(19) United States
(12) Patent Application Publication
(10) Pub. No.: US 2004/0075028 A1
(43) Pub. Date: Apr. 22, 2004

(54) Kit of parts and a method for converting between a glider and a kite

(76) Inventor: Jung-Yuan Wang, Mississauga (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/462,777

(22) Filed: Jun. 17, 2003

Related U.S. Application Data
(60) Provisional application No. 60/388,755, filed on Jun. 17, 2002.

(51) Int. Cl. F41J 9/08; A63H 27/08; B64C 31/06

(52) U.S. Cl. 244/154

(57) ABSTRACT

A kit of parts and a method for converting between a glider and a kite. The kit of parts includes a body, a kite wing and a glider wing. The kite wing is removably connectable to the body so that the body and the kite wing can be connected to a kite string and flown as a kite. The glider wing is removably connectable to the body so that the body and the glider wing can be flown as a glider.

### FIELD OF THE INVENTION

The invention is directed to flying toys, and more particularly to a kit of parts that can be configured to operate as a kite or as a glider.

### BACKGROUND OF THE INVENTION

Kites and gliders are well known flying toys that people can fly for enjoyment. Relative to gliders, kites typically require a greater amount of wind (ie. a higher wind speed) to support their flight. Gliders typically require a lesser amount of wind (ie. a lower wind speed) to support their flight, and typically do not function well in high-wind conditions.

A user's favourite kite-flying location may be a park or some other open area that may not be in the immediate vicinity of the user's home. It can be difficult to predict the wind conditions at the flying location if it not in the immediate vicinity of the user's home, since wind conditions can be closely tied to features of the immediate environment of the area in question. Thus, a user may think that winds are sufficient to support the flight of their kite because of wind conditions around their home, only to travel to the flying location and discover that there is not enough wind in that location. Alternatively, he may think that it is a relatively calm day so that he can fly his glider, only to discover that winds are too strong and unsteady for flying a glider. This can be particularly frustrating to a kite flyer if the user had to travel a long distance to get to the area.

Thus, there is a need for a flying toy that can be adapted for use in a broad range of wind conditions.

### SUMMARY OF THE INVENTION

In a first aspect, the invention is directed to a kit of parts for a device that is convertible between a kite and a glider. The kit of parts includes a body, a first wing, a second wing and connecting means. The first wing is connectable to the body and is sufficiently rigid to enable flight as a glider. The second wing is removably connectable to at least one of the body and the first wing and is adapted for increasing the total wing surface area sufficiently for flight as a kite when a kite string is attached to at least one of the body, the first wing and the second wing. The connecting means is for connecting the first and second wings to the body.

In one embodiment of the first aspect, the first wing remains attached to the body when the second wing is connected, so that the first and second wings together have a total wing surface area that is sufficient for flight as a kite.

In another embodiment of the first aspect, the first wing is removed when the second wing is connected.

In a second aspect, the invention is directed to a kit of parts for a device that is convertible between a kite and a glider. The kit of parts includes a body, a wing connected to the body, and at least one rib. The wing includes a front spar, a rear spar and a fabric skin extending between the front and rear spars. At least one of the body and the wing is connectable to a kite string for flight as a kite. The at least one rib is removably connectable between the front and rear spars to make the wing sufficiently rigid so that the wing and the body may be flown as a glider.

In a third aspect, the invention is directed to a method of converting a kite to a glider, the kite comprising a body, a kite wing removably attached to the body, and a kite string that is removably attached to at least one of the body and the kite wing, the method comprising completing the following steps in any order:

removing the kite string from the at least one of the body and the kite wing;

removing the kite wing from the body; and

attaching a glider wing to the body, the glider wing being sufficiently rigid to enable flight as a glider.

In a fourth aspect, the invention is directed to a method of converting a kite to a glider, the kite comprising a body, a wing attached to the body, and a kite string removably attached to at least one of the body and the wing, the wing including a front spar, a rear spar and a fabric skin extending between the front and rear spars, the method comprising completing the following steps in any order:

removing the kite string from the at least one of the body and the wing; and

attaching at least one wing rib between the front and rear spars to stiffen the wing.

In a fifth aspect, the invention is directed to a method of converting a glider to a kite, the glider comprising a body, a wing attached to the body, the wing including a front spar, a rear spar, a fabric skin extending between the front and rear spars, and at least one rib connected between the front and rear spars, the method comprising completing the following steps in any order:

removing the at least one wing rib from between the front and rear spars to reduce the stiffness of the wing; and

adding a kite string to at least one of the body and the wing.

In a sixth aspect, the invention is directed to a method of converting a glider to a kite, the glider comprising a body, a first wing attached to the body, the first wing being a glider wing, the method comprising completing the following steps in any order:

attaching a second wing to the body to increase the overall wing surface area; and

attaching a kite string to at least one of the first wing, the second wing and the body.

### DESCRIPTION OF THE DRAWINGS

For a better understanding of the present invention and to show more clearly how it may be carried into effect, reference will now be made by way of example to the accompanying drawings, in which:

FIG. 1 is a perspective view of a kit of parts for a device that is convertible between a kite and a glider in accordance with a first embodiment of the present invention;

FIG. 2 is a perspective view of a kite assembled from the kit of parts shown in FIG. 1;

FIG. 3 is a perspective view of a glider assembled from the kit of parts shown in FIG. 1;

FIG. 4 is a perspective view of the body from the kit of parts shown in FIG. 1;

FIG. 5 is a bottom plan view of a kite wing from the kit of parts shown in FIG. 1;

FIG. 5a is a sectional side view through section 5a-5a of the kite wing shown in FIG. 5;

FIG. 6 is a side elevation view of the kite wing shown in FIG. 5, during flight;

FIG. 7 is a bottom plan view of a glider wing from the kit of parts shown in FIG. 1;

FIG. 7a is a sectional side view through section 7a-7a of the glider wing shown in FIG. 7;

FIG. 8 is a side elevation view of the glider shown in FIG. 3, during flight;

FIG. 9a is a side elevation view of the glider shown in FIG. 3, during flight showing that the glider may have a nose-up attitude;

FIG. 9b is a side elevation view of the glider shown in FIG. 3, during flight showing that the attitude of the glider may be adjusted using an added weight;

FIG. 10 is a perspective view of an optional weight and an optional weight receptacle shown in FIG. 1;

FIG. 11 is a perspective view of a set of other optional weights;

FIG. 12 is an exploded, perspective view of an optional propeller assembly shown in FIG. 1;

FIG. 13 is a side view of the path of a glider shown during flight;

FIG. 14 is a perspective view of a kit of parts for a device that is convertible between a kite and a glider in accordance with a second embodiment of the present invention;

FIG. 15 is a perspective view of a kite assembled from the kit of parts shown in FIG. 14;

FIG. 16 is a perspective view of a glider assembled from the kit of parts shown in FIG. 14;

FIG. 17 is a bottom plan view of a common wing shown in FIG. 14;

FIG. 17a is a sectional side view through section 17a-17a of the common wing shown in FIG. 17;

FIG. 18 is an exploded, perspective view of a propeller assembly shown in FIG. 14;

FIG. 19 is a perspective view of a kit of parts for a device that is convertible between a kite and a glider in accordance with a third embodiment of the present invention;

FIG. 20 is a perspective view of a glider assembled from the kit of parts shown in FIG. 19;

FIG. 21 is a perspective view of a kite assembled from the kit of parts shown in FIG. 19;

FIG. 22 is a perspective view of a body from the kit of parts shown in FIG. 19;

FIG. 23 is a perspective view of the underside of the body and the glider wing from the kit of parts shown in FIG. 19;

FIG. 23a is a sectional side view through section 23a-23a of the glider wing shown in FIG. 23;

FIG. 24 is a perspective view of the kite wing from the kit of parts shown in FIG. 19;

FIG. 24a is a sectional side view through section 24a-24a of the kite wing shown in FIG. 24 FIG. 25 is a perspective view of an alternative pair of weight receptacles for use with any of the kits of parts of the present invention;

FIG. 26a is an exploded perspective view of an alternative propeller assembly for use with any of the kits of parts of the present invention;

FIG. 26b is a perspective view of the propeller assembly shown in FIG. 26a in its assembled state;

FIG. 27a is an exploded perspective view of an alternative body for use with any of the kits of parts of the present invention; and

FIG. 27b is a perspective view of the body shown in FIG. 26a in its assembled state.

### DESCRIPTION OF THE PREFERRED EMBODIMENT

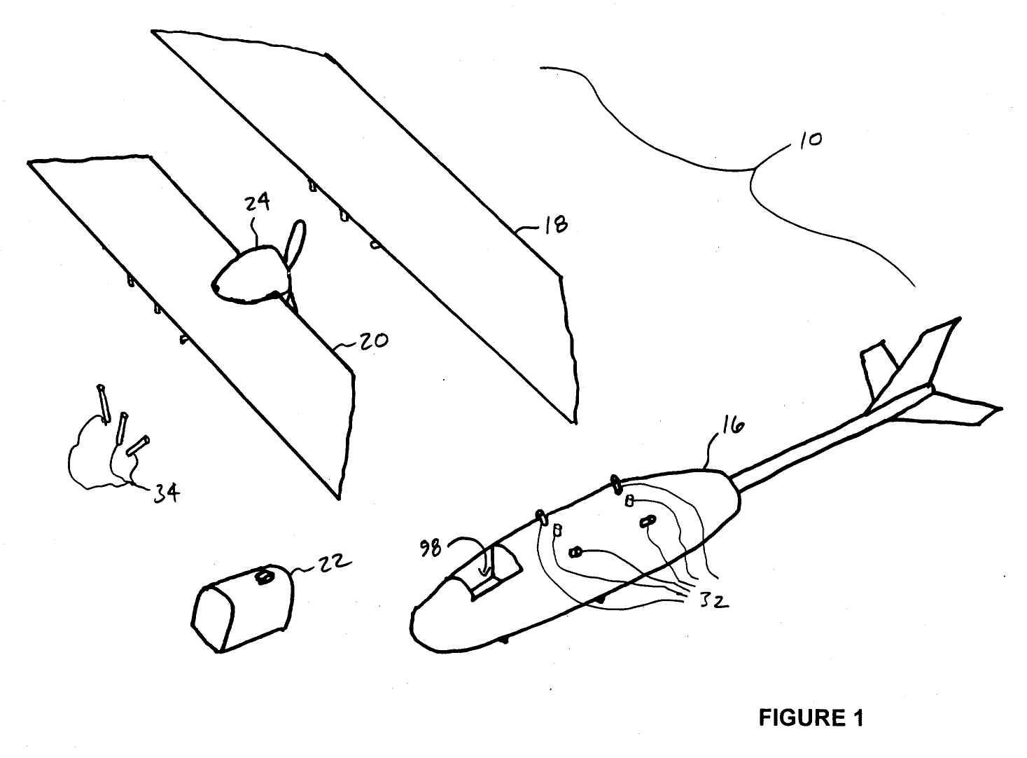

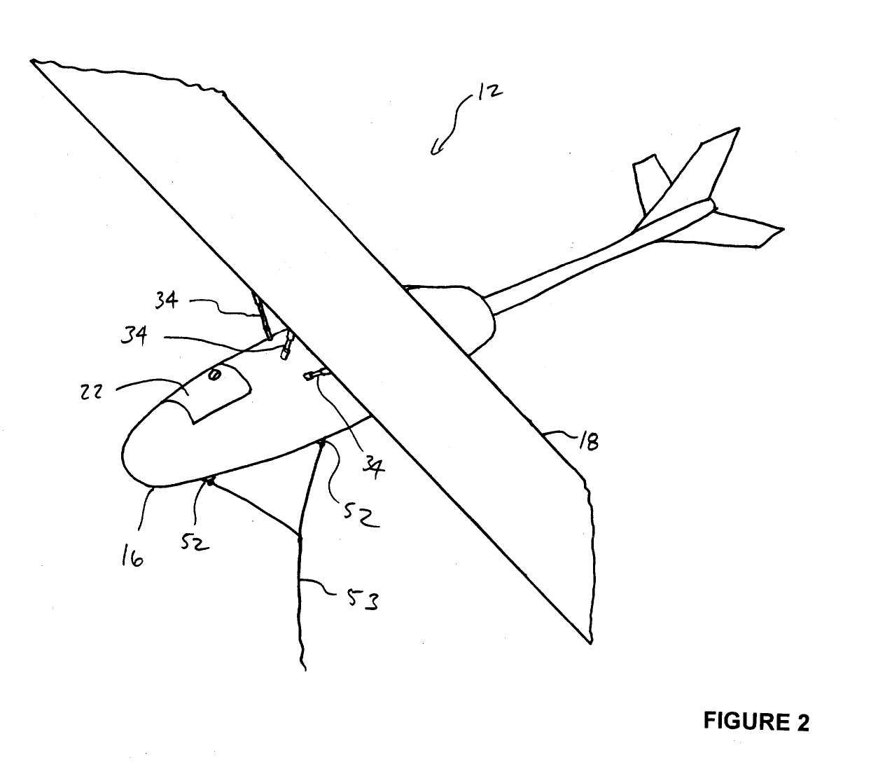

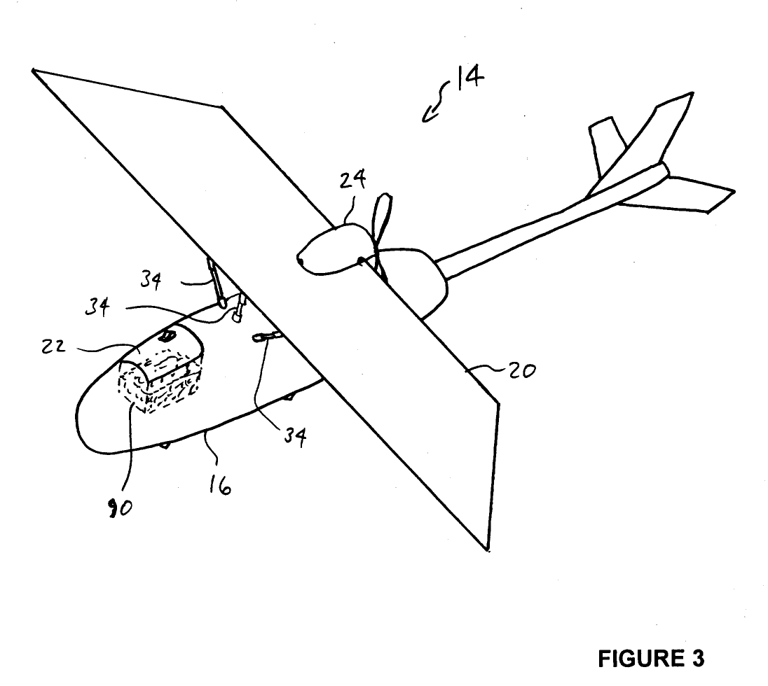

Reference is made to FIG. 1, which shows a kit of parts 10 in accordance with a first embodiment of the present invention. The kit of parts 10 can be used to assemble a kite 12 as shown in FIG. 2, or a glider 14 as shown in FIG. 3, depending on the preference of the user.

The kite 12 may be used in conditions, for example, where the wind is too strong or unstable for the flight of glider 14, or alternatively simply because the user wishes to fly a kite. The glider 14 may be used in conditions, for example, where the wind is not strong enough to support the flight of kite 12, or, alternatively, simply because the user wishes to fly a glider. The kite 12 and glider 14 may both have a configuration to resemble an airplane in flight, as shown in the Figures. Alternatively, they may have configurations for flight as a kite or as a glider that do not resemble aircraft.

Referring to FIG. 1, the kit of parts 10 comprises a body 16, a kite wing 18 and a glider wing 20, and may optionally include a weight receptacle 22 and a propeller assembly 24. The body 16 may be used in both the kite and the glider 14, and is preferably resistant to damage due to impacts with the ground. Furthermore, due to its use in the glider 14, the body 16 may also soft to reduce the risk of injury to a bystander in the event that the glider 14 collides with the bystander during flight.

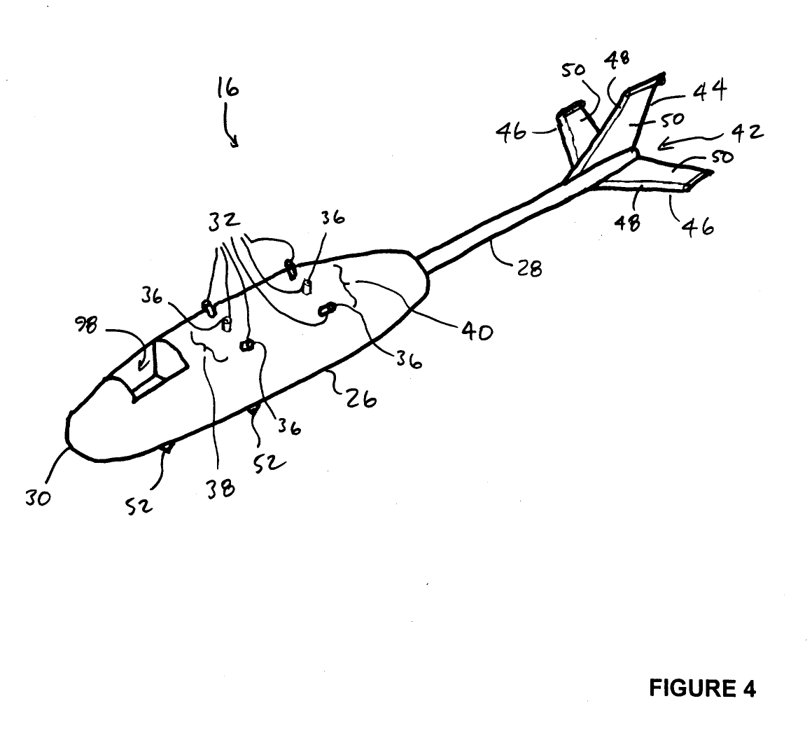

Reference is made to FIG. 4. The body 16 may comprise a front portion 26 and a rear portion 28. The front portion 26 may be made out of an expanded plastic such as expanded polyurethane, which is both soft and impact resistant. Because the front portion 26 is the portion that is likely to impact a bystander in the event of a collision, the softness reduces the risk of injuring the bystander. The impact resistance reduces the risk of damage to the front portion 26 during collisions with anything, for example, the ground. The rear portion 28 may be made out of a rigid plastic such as nylon tubing which is strong and light. The rear portion 28 may be joined to the front portion 26, for example by being glued or friction fit into an aperture in the rear of the front portion 26.

The body 16 may be shaped similarly to an aircraft fuselage. For example, the body 16 may be shaped like the fuselage of an ultralight aircraft. The body 16 may have a nose 30 that is rounded to resist damage from impacts. The rounded shape of the nose 30 also reduces the risk of injury to a bystander in the event of a collision therewith during flight.

The body 16 has a plurality of receptacles 32 for receiving connecting rods 34 as shown in FIGS. 2 and 3. Receptacles 32 may be any suitable means for receiving the connecting rods 34. For example, receptacles 32 may be made from a semi-rigid plastic, such as nylon, and may each have a cylindrical pocket 36 which is sized to provide a friction fit with one of the connecting rods 34. The receptacles 32 may themselves be friction fit or preferably glued into apertures in the front portion 26.

The connecting rods 34 are used to connect either or both of the kite wing 18 and the glider wing 20 to the body 16. The receptacles 32 may be positioned on the body 16 in any suitable orientation to support the kite and glider wings 18 and 20 securely to the body 16. For example, the body 16 may have a first row 38 of receptacles 32 for holding the leading edge of the wings 18 and 20, and a second row 40 of receptacles 32 for holding the trailing edge of the wings 18 and 20.

The body 16 has a rear or tail end 42 on the rear portion 28. The tail end 42 may have a vertical stabilizer 44 and a pair of horizontal stabilizers 46. The vertical and horizontal stabilizer 44 may be made from a semi-rigid rod 48 which is bent into a desired shape, with a fabric skin 50 mounted thereon. The rod 48 can be bent into a shape to define the outline of the vertical stabilizer 44. The fabric skin 50 can be sewn onto or otherwise mounted to the rod 48 to make up the surface of the vertical stabilizer 44. The horizontal stabilizers 46 may similarly be made from a rod 48 and a fabric skin 50.

The rods 48 may be made from a semi-rigid material such as a suitable metal wire or polymer rod of a suitable gauge. The fabric skin 50 may be made from a suitably light and strong material, such as nylon.

The body 16 has a plurality of attachment points 52, to which a kite string 53 may be attached. The attachment points 52 may comprise metallic rings that are attached to body 16 by any suitable means. For example the metallic rings may be attached to piece of fabric with are glued onto the body.

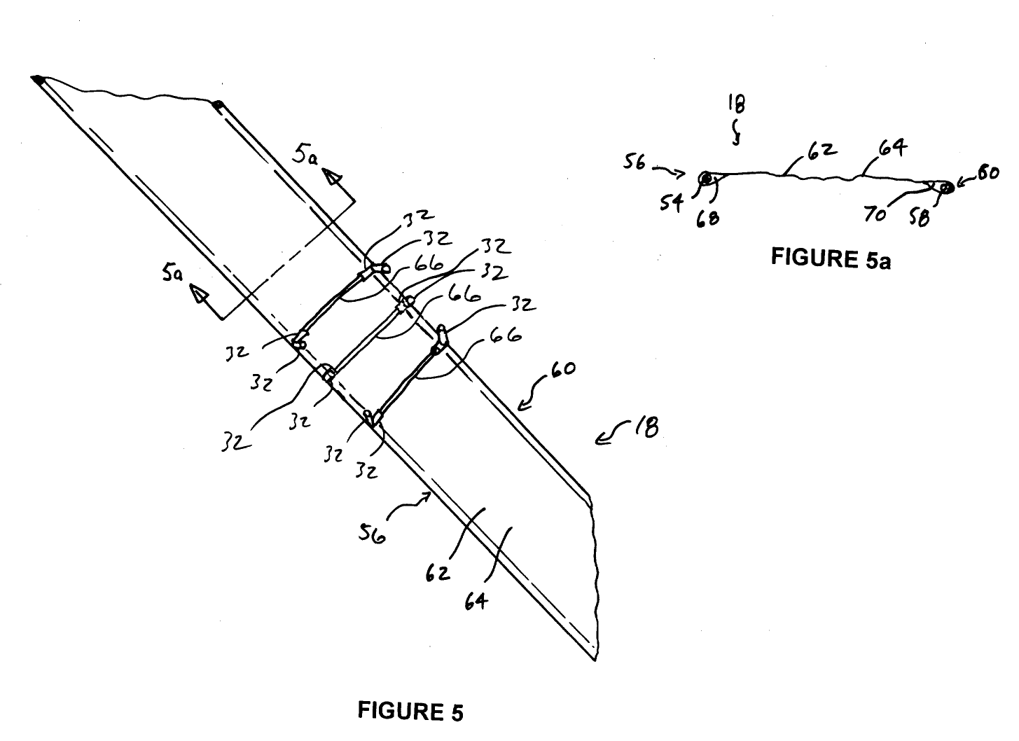

Reference is made to FIG. 5. The kite wing 18 can be mounted to the body 16 when the user wishes to assemble and fly kite 12 from the kit of parts 10. The kite wing 18 may have a configuration to resemble an aircraft wing, such as, for example, a wing from an ultralight aircraft.

The kite wing 18 may be made in any suitable way. For example, as shown in FIG. 5a, the kite wing 18 may comprise a front spar 54 which extends along the leading edge, shown at 56, a rear spar 58 which extends along the trailing edge 60, and a fabric skin 62 which extends between the front and rear spars 54 and 58, to form a wing surface 64. The front spar 54 may extend across substantially the entire leading edge 56. The rear spar 58 may extend across all or some portion of the trailing edge 60. The front and rear spars 54 and 58 may be semi-rigid and may be made from a material such as nylon rod.

The fabric skin 62 may include a leading edge pocket 68 and a trailing edge pocket 70, which receive and retain the front and rear spars 54 and 58 respectively. The fabric skin 62 may be made from a suitably strong and light material, such as nylon.

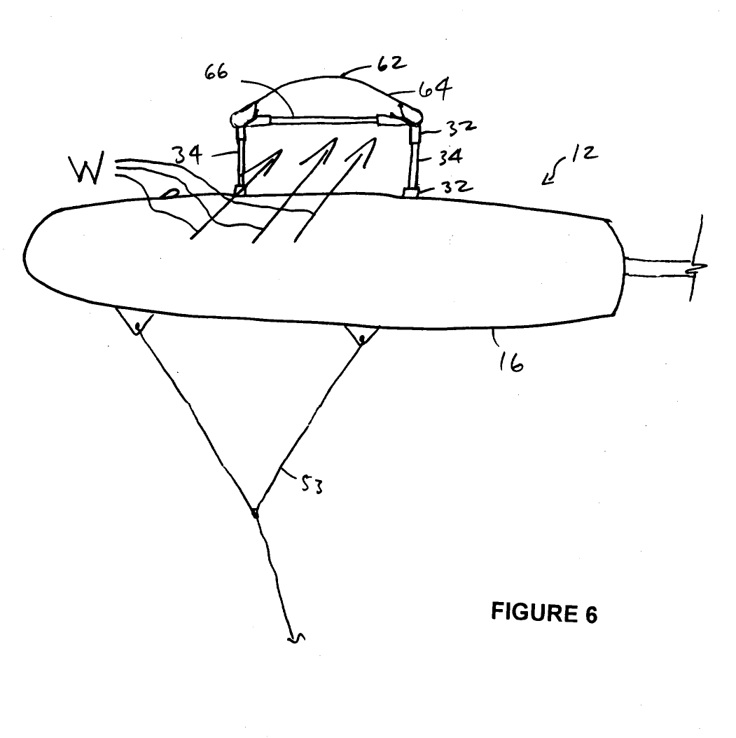

Referring to FIG. 5, the kite wing 18 may also optionally include one or more ribs 66. The leading edge and rear spars 54 and 58 may be joined together by the optionally included ribs 66. The ribs 66 may extend generally longitudinally (along the direction of flight), between the front and rear spars 54 and 58, and may be connected to receptacles 32 that are suitably positioned on the spars 54 and 58. The ribs 66 may extend perpendicularly between the front and rear spars 54 and 58 or the ribs 66 may extend diagonally between the front and rear spars 54 and 58. The ribs 66 may provide added strength to the kite wing 18. As a further alternative, the ribs 66 may have a length that is shorter than the length of the fabric skin 62 between the front and rear spars 54 and 58, so that the fabric skin 62 extends loosely and is not stretched taut between the spars 54 and 58. By loosely extending the fabric skin 62 between the spars 54 and 58, the fabric skin 62 can bow and ‘catch’ the wind, when the kite 12 is in flight, as shown in FIG. 6. The direction of the wind is illustrated by the arrows W.

Referring to FIG. 6, the kite wing 18 includes means for connecting the kite wing 18 to the body 16. For example, the kite wing 18 may also include on the front and rear spars 54 and 58, a plurality of receptacles 32 for receiving connecting rods 34, to connect the kite wing 18 to the body 16. If the connections between the front and rear spars 54 and 58 and the body 16 are suitably strong and rigid, then ribs 66 may not be required.

Once the kite wing 18 is mounted to the body 16 and the kite string 53 is connected to the body 16, the kite 12 is complete and ready for flight.

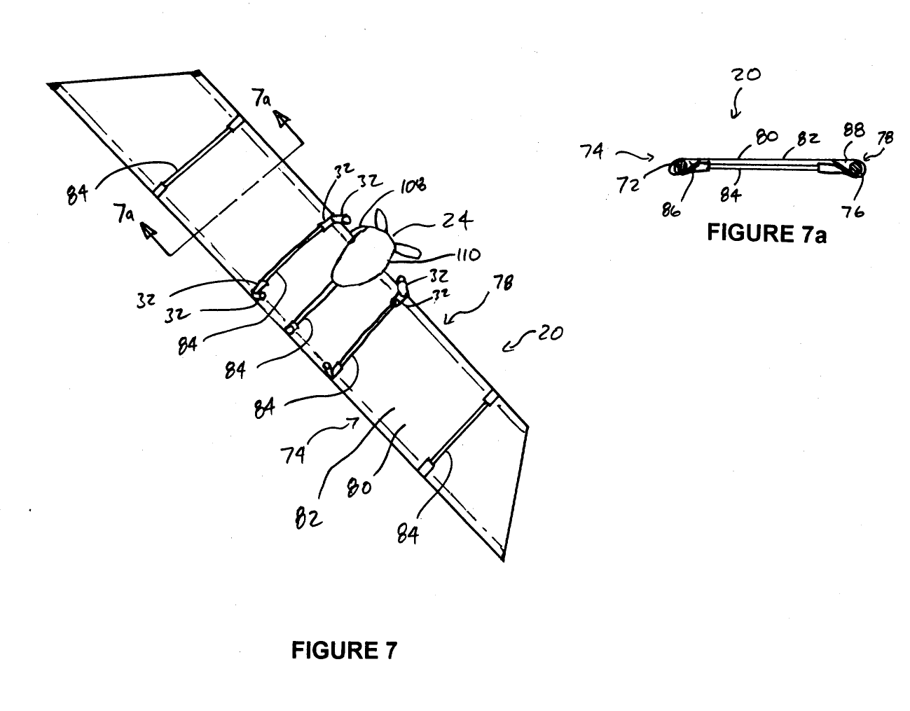

Reference is made to FIG. 7. The glider wing 20 is mounted to the body 16 when the user wishes to assemble and fly glider 14 from the kit of parts 10. The glider wing 20 may have a configuration to resemble an aircraft wing, such as, for example, a wing from an ultralight aircraft. In general, the glider wing 20 may be similar to the kite wing 18, however the glider wing 20 may have a more rigid structure than the kite wing 18 in order to have consistent aerodynamic properties when the glider 14 is in flight. The glider wing 20 may also have a smaller surface area than the kite wing 18, since it has been observed that in general, less wing surface area is required for glider flight than for kite flight, for a glider and a kite having a similar weight and shape.

The glider wing 20 may be made in a way that is similar to the kite wing 18. For example, as shown in FIG. 7a, the glider wing 20 may comprise a front spar 72 which extends along the leading edge, shown at 74, a rear spar 76 which extends along the trailing edge 78, a fabric skin 80 which extends between the front and rear spars 72 and 76, to form a wing surface 82. The glider wing 20 may optionally include a plurality of ribs 84. The front spar 72 may extend across substantially the entire leading edge 74. The rear spar 76 may extend across all or some portion of the trailing edge 78. The front and rear spars 72 and 76 may be semi-rigid and may be made from a material such as nylon rod.

The fabric skin 80 may include a leading edge pocket 86 and a trailing edge pocket 88, which receive and retain the front and rear spars 72 and 76 respectively. The fabric skin 80 may be made from a suitably strong and light material, such as nylon.

The leading edge and rear spars 72 and 76 may be joined together by the optionally included ribs 84. The ribs 84 extend generally longitudinally between the front and rear spars 72 and 76, and may be connected to receptacles 32 that are suitably positioned on the spars 72 and 76. The ribs 84 may extend perpendicularly between the front and rear spars 72 and 76 or the ribs 84 may extend diagonally between the front and rear spars 72 and 76.

The fabric skin 80 is generally taut between the front and rear spars 72 and 76, for the function of the glider wing 20. The tautness of the fabric skin 80 may be maintained by any suitable means, such as for example, the inclusion of the ribs 84 between the front and rear spars 72 and 76. During flight, the taut fit permits the fabric skin 80 to have relatively consistent and stable aerodynamic lift and drag properties, permitting improved gliding performance, relative to a wing having a loosely extending wing fabric.

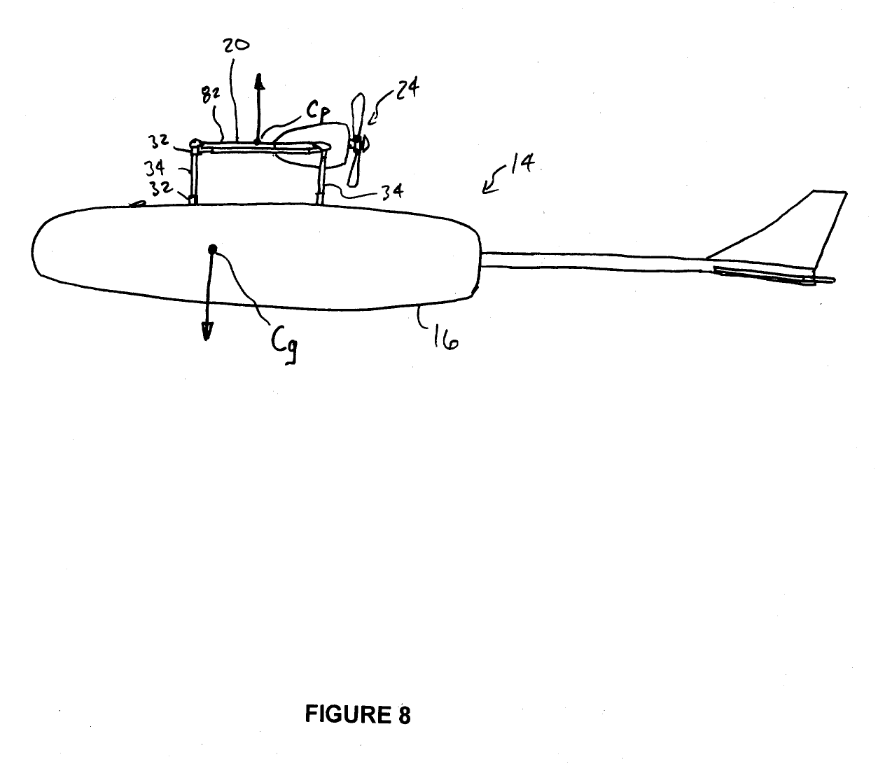

The glider wing 20 includes a means for connecting to the body 16. For example, the glider wing 20 may include on the front and rear spars 72 and 76, a plurality of receptacles 32 for receiving connecting rods 34 (see FIG. 8) to connect the glider wing 20 to the body 16.

It is optionally possible that the connection of the front and rear spars 72 and 76 to the body 16 by the connecting rods 34 may be made sufficiently rigid to maintain the tautness of the fabric skin 80 instead of, or in conjunction with the ribs 84.

For the purposes of this disclosure, the glider wing 20 may also be referred to as the first wing 20 and the kite wing 18 may be referred to as the second wing 18. Furthermore, the front and rear spars 72 and 76 of the glider wing 20 may be referred to as the first front and rear spars 72 and 76. Similarly, the front and rear spars 54 and 58 of the kite wing 18 may be referred to as the second front and rear spars 54 and 58. The fabric skin 80 of the glider wing 20 may be referred to as the first fabric skin 80 and the fabric skin 62 of the kite wing 18 may be referred to as the second fabric skin 62. The wing ribs 84 of the glider wing 20 may be referred to as the first wing ribs 84 and the wing ribs 66 of the kite wing 18 may be referred to as the second wing ribs 66.

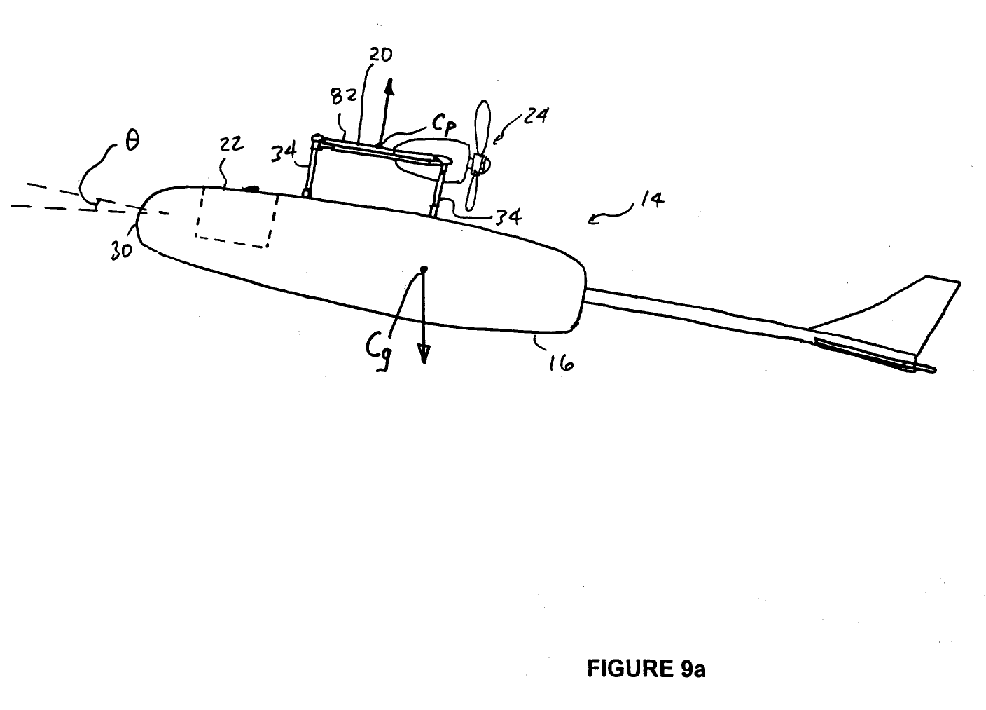

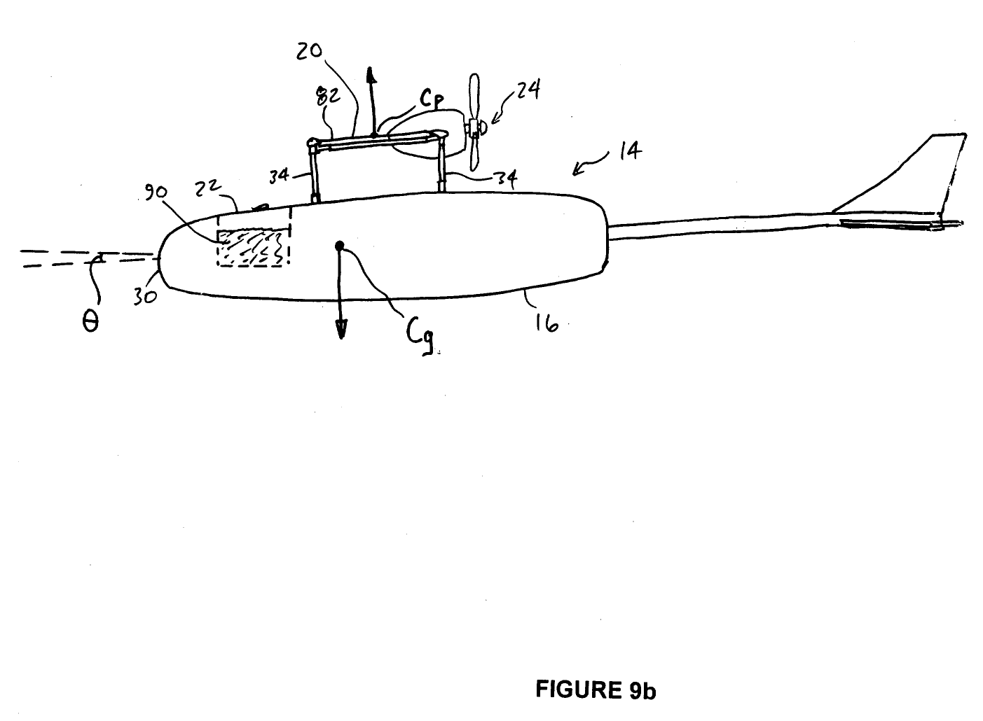

Reference is made to FIGS. 9a and 9b. When the glider 14 is in flight, the center of pressure of the glider 14 is at a point Cp, which is somewhere along the surface 82 of the wing 20. The center of gravity of the glider 14 is at a point Cg which is somewhere along the length of the glider 14. Referring to FIG. 9b, the optional weight receptacle 22 can be positioned at a suitable point along the body 16 and can be filled with a weighted product 90 to maintain stability in the angle of attack of the glider 14, and to maintain the angle of attack Θ of the glider 14 to be slightly downwards, which is generally advantageous for glider flight. Care must be taken to ensure that the added weight of the weighted product 90 must not be so large as to render the glider wing 20 incapable of supporting the glider 14 in flight.

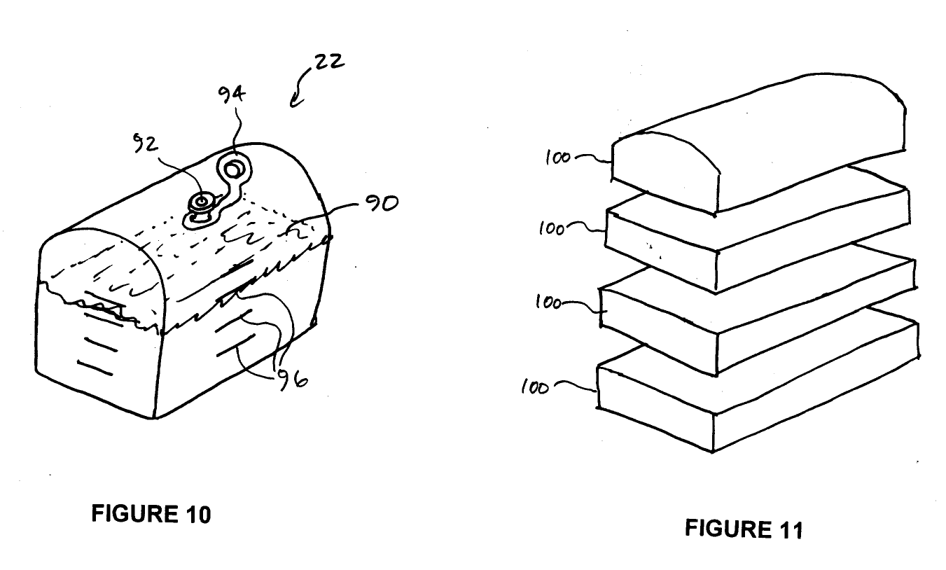

Reference is made to FIG. 10. The weight receptacle 22 may have an opening 92 and a lid 94, for filling with and sealing therein the weighted product 90. The weighted product 90 may be any suitable product, such as, for example, water or sand. The weight receptacle 22 may include graduations 96 to indicate a suitable fill level of weighted product 90 for use in different wind conditions. Optionally, there may be graduations for several different types of weighted product 90, to provide the user with more flexibility in terms of the product used.

Referring to FIG. 1, the weight receptacle 22 may be positioned, for example, in an aperture 98 in the front portion 26 of the body 16. The aperture 98 may be configured to frictionally engage the weight receptacle 22 to retain it therein. Once in position in the aperture 98, the weight receptacle 22 reduces any instability or drag that would be caused by the aperture in flight. Thus, it may be that the weight receptacle is inserted empty into the aperture 98 when the kite 12 is used, simply for the purpose of filling the aperture 98 and thereby increasing the stability of the kite 12 in flight.

The weight receptacle 22 has been described as being removably mountable in the body 16. It is alternatively possible for the weight receptacle 22 to be integrally included in the body 16. In this case, the weight receptacle 22 is filled when the user wishes to fly the glider 14, but can simply be emptied when the user wishes to fly the kite 12.

As a further alternative, the weight receptacle 22 and weighted product 90 may be replaced by a set of individual weights 100 (see FIG. 11), one or more of which may be positioned in the aperture 98 on the glider 14 depending on the total weight required to compensate for the wind conditions at the time of flight.

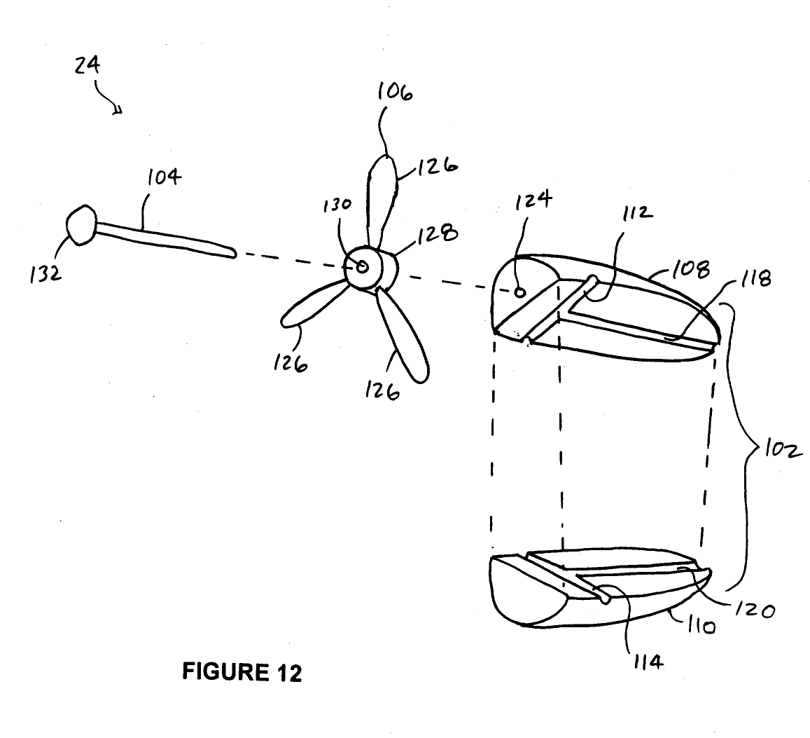

Reference is made to FIG. 12. The optional propeller assembly 24 is passive and spins in response to the movement of the glider 14 through the air. The propeller assembly 24 includes a housing 102, a shaft 104 and a propeller 106. The housing 102 may be configured generally to resemble an engine cowling on an engine-driven propeller on a real aircraft. The housing 102 may be made from a relatively light, soft material that can withstand the shock of impact when the glider 14 hits the ground or collides with an object in flight. For example, the housing 102 may be made from expanded polyurethane.

The housing 102 may be mounted to the glider wing 20 in any suitable way. For example, the housing 102 may include an upper portion 108 and a lower portion 110. The upper and lower portions 108 and 110 include transverse channels 112 and 114 respectively, which together define an aperture for receiving the trailing edge wing spar 76. The upper and lower portions 108 and 110 may also include longitudinal channels 118 and 120, which extend longitudinally from the ends of the upper and lower portions 108 and 110 respectively, to intersect the transverse channels 112 and 114. The channels 118 and 120 together define an aperture for receiving a rib 84 and receptacle 32. The mounting of housing 102 at a junction of the rear spar 76 and a rib 84 (see FIG. 7) better maintains the housing 102 in position on the wing 20, and better maintains the orientation of the propeller 24 in flight, relative to a mounting over the spar 76 only.

A second longitudinal aperture 124 is a blind aperture and may be defined in either of the upper and lower portions 108 or 110, such as, for example the upper portion 108, for receiving the shaft 104. The shaft 104 may be fixed in the aperture 124 in any suitable way, such as, for example, with an adhesive. The shaft 104 may be made from a relatively rigid material such as nylon.

The propeller 106 includes a plurality of blades 126 arranged around a central annulus 128. The central annulus 128 defines a central aperture 130, which rotatably mounts onto the shaft 104. The propeller 106 may be made from a semi rigid material such as expanded polyurethane to reduce the risk of injury from the blades 106 in the event of a collision between the glider and a person.

A retaining head 132 that is generally conical may be integrally included on the shaft 104 for retaining the propeller 106 on the shaft 104. Low friction is preferably maintained between the central annulus 128 and the retaining head 132 and between the central annulus 128 and the housing 102. The friction between the central annulus 128 and the housing 102 is less important in the configuration shown in FIG. 3, however, because the movement of the glider 14 through the air will push the propeller 106 against the retaining head 132.

As shown in FIG. 7, the propeller assembly 24 may be assembled around the rear spar 76 and the rib 84 of the glider wing 20. The fabric skin 80 of the glider wing 20 will be sandwiched between the upper and lower portions 108 and 110 on at least a portion of their mating surfaces. A superbond adhesive may be used to glue the upper and lower portions 108 and 110 together and to the fabric skin 80, the rear spar 76 and the rib 84. In this way, the propeller assembly 24 may be permanently mounted to the glider wing 20.

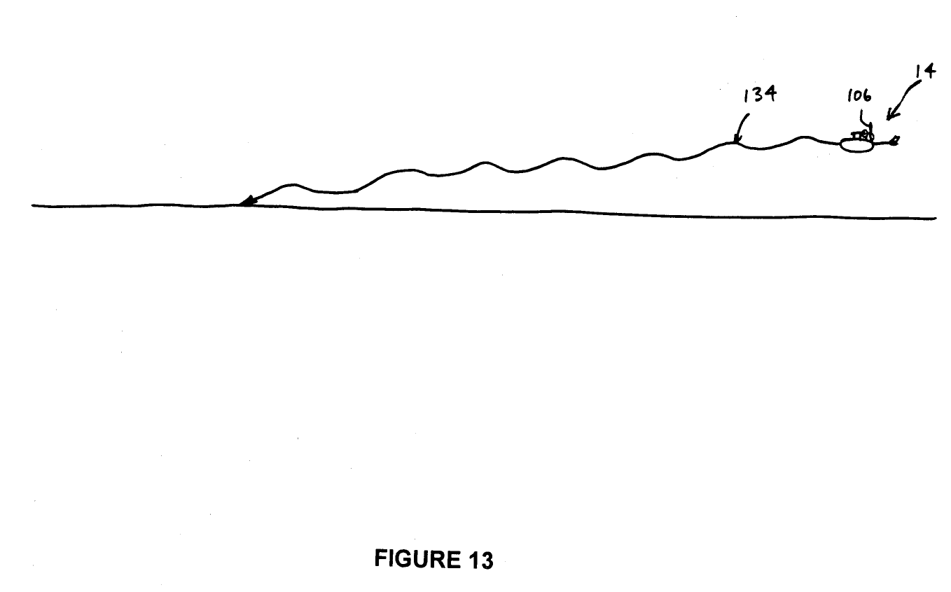

The propeller assembly 24 acts as a velocity regulator for the glider 14 in flight. During flight, it has been observed that the glider 14 without the propeller 24 flies generally in a path shown at 134 in FIG. 13. In flight when the glider 14 has a nose-up angle of attack Θ (as shown in FIG. 9a) there is an increased risk that the glider 14 will stall in the air, potentially ending its flight. It is therefore advantageous to maintain the glider 14 in a slight nose-down attitude to reduce the risk of stalling. The addition of the propeller assembly 24 smoothes out the flight path 134, reducing the risk of the glider 14 stalling. It is theorized that the propeller assembly 24 acts as a damper to changes in the speed of the glider 14 and thus reduces the magnitudes of the changes in angle of attack Θ.

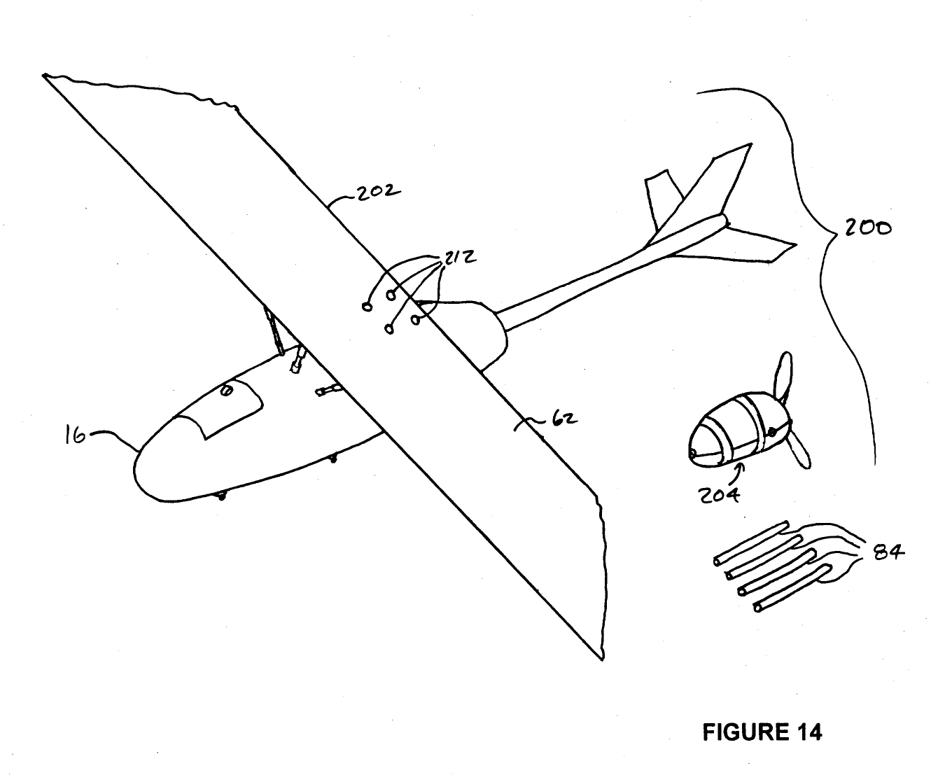

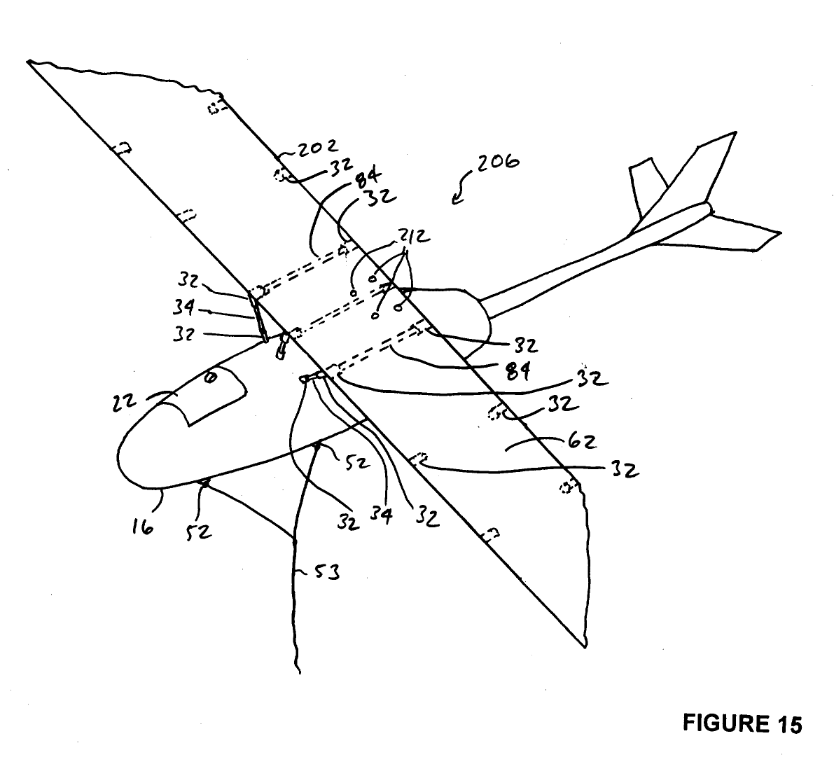

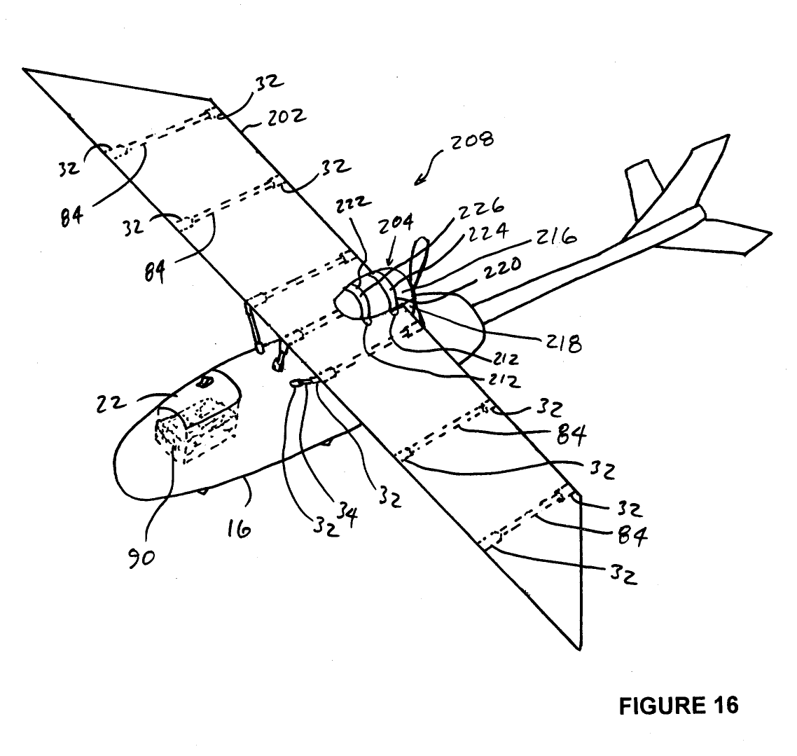

Reference is made to FIG. 14, which shows a kit of parts 200 in accordance with another embodiment of the present invention. The kit of parts 200 includes the body 16, a common wing 202, a plurality of ribs 84, optionally the weight receptacle 22, and also optionally a propeller assembly 204. Like the kit of parts 10, the kit of parts 200 may be configured as a kite 206 (see FIG. 15) or as a glider 208 (see FIG. 16). The kit of parts 200 is similar to the kit of parts 10, except that the kit of parts 200 has the common wing 202 can be used as part of both the kite 206 and the glider 208.

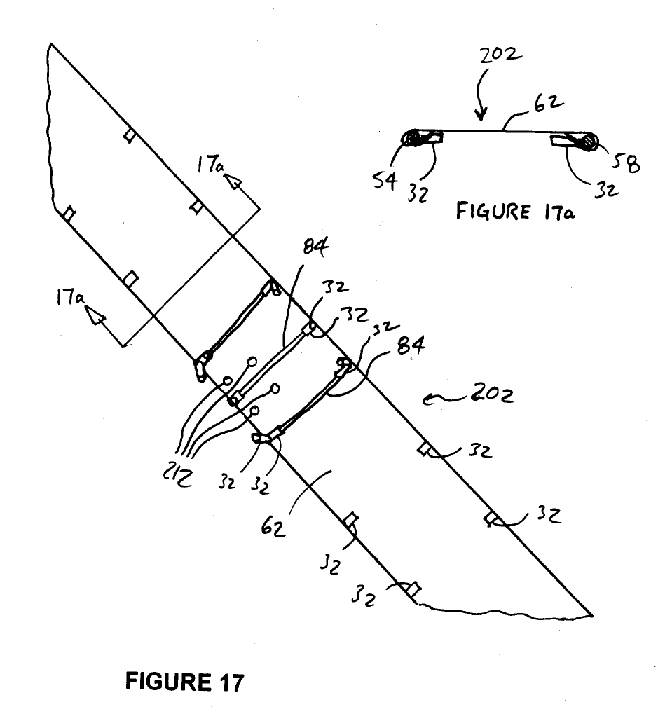

Reference is made to FIGS. 17 and 17a. The common wing 202 is similar to the kite wing 18 of FIG. 5, except that the common wing 202 includes means for the mounting of a plurality of ribs 84 thereon, and may also include means for the mounting of the optional propeller assembly 204. The common wing 202 includes the front spar 54, the rear spar 58 and the fabric skin 62 which extends between the front and rear spars 54 and 58.

The means for mounting the ribs 84 may include a plurality of receptacles 32 attached to the front and rear spars 54 and 58. When the common wing 202 is used as a kite wing (see FIG. 15), some of the ribs 84 may be inserted into the receptacles 32, while some may not be required. When the common wing 202 is used as a glider wing (see FIG. 16), more of the ribs 84 are inserted into the receptacles 32, to structurally stiffen the common wing 202.

Referring to FIG. 14, the common wing 202 can be mounted to the body 16 by means of connector rods 34 connected between receptacles 32 mounted on the wing 202 and the body 16. Using this mounting, the common wing is removable from the body 16. Alternatively however, the common wing 202 may be fixedly mounted to the body 16, since the common wing 202 and the body 16 are used for both the kite 206 (see FIG. 15) and the glider 208 (see FIG. 16). The fixed mounting may be achieved for example, by using an adhesive to permanently mount the connecting rods 34 in the receptacles 32 on the wing 202 and the body 16.

The means for mounting the propeller assembly 204 may include four holes 212 through the fabric skin 62. The holes 212 may be arranged in two transverse pairs which are spaced longitudinally. The propeller assembly 204 may be similar to the propeller assembly 24, except that the propeller assembly 204 may be removably mounted to the common wing 202, instead of being permanently mounted with adhesive or the like.

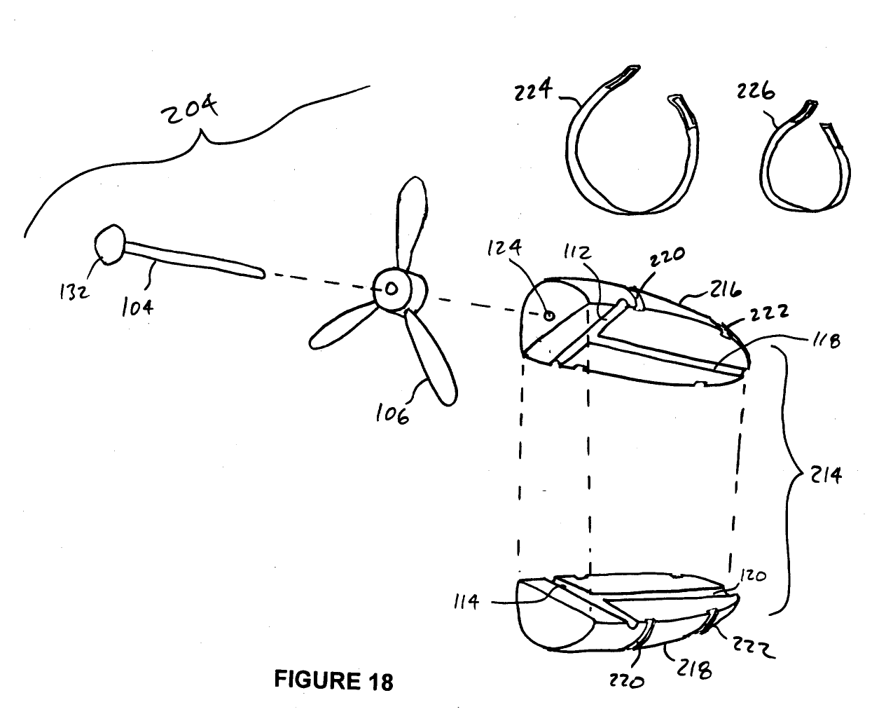

Reference is made to FIG. 18. The propeller assembly 204 includes a housing 214, shaft 104 and propeller 106. The housing 214 includes an upper portion 216 and a lower portion 218. The housing 214 is similar to the housing 102, except that the housing 214 includes means for removably mounting the propeller assembly 204 to the common wing 202. The removable mounting means may include first and second circumferential channels 220 and 222 that encircle the housing 214 transversely near each end. The channels 220 and 222 align with the holes 212 on the wing 202.

The removable mounting means may further include first and second straps 224 and 226 that fit into the channels 220 and 222 respectively. The straps 224 and 226 may optionally be elastic and may include ends having a hook and fabric fastener thereon, such as Velcro™, so that the ends can be joined and the straps can hold the upper and lower portions 216 and 218 together. Alternatively, the ends may be joined together by any other suitable means, such as simply tying the ends together.

Reference is made to FIG. 15. When it is desired to fly kite 206, the body 16 and attached common wing 202 may simply be connected to kite string 53. The propeller assembly 204 may optionally be attached to the wing 202 so that the kite further resembles an aircraft. The kite 206 is then ready for flight.

Reference is made to FIG. 16. When it is desired to fly glider 208, the wing 202 is reinforced using the ribs 84 and the optional propeller assembly 204 may be mounted on the wing 202. The ribs 84 are mounted into the receptacles 32 on the front and rear spars 54 and 58 to provide added stiffness to the wing and added tautness to the fabric skin 62. The upper and lower portions 216 and 218 are positioned on the wing 202 to capture the rear spar 58 and optionally one of the ribs 84. The straps 224 and 226 are fed through the holes 212 in the wing 202, and are positioned to extend around the housing 214 in the channels 220 and 222. The ends of the straps 224 and 226 are then joined together to secure the propeller assembly 204 to the wing 202. The optional weight receptacle 22 may be configured to hold a selected weight based on the wind conditions, and may be positioned on the body 16, in the same manner as with the embodiment shown in FIGS. 1-13. The glider 208 is then ready for flight.

It will be noted that the surface area of the common wing 202 does not change whether it is used as a kite wing or as a glider wing. Common wing 202 is configured to have a surface area necessary to support the flight of kite 206. Since glider 208 has more wing surface area than is necessary for its weight to be supported in flight, more weighted product 90 may be used in weight receptacle 22 to compensate for the increased wing surface area relative to glider 14. The extra weighted product 90 increases the stability of the glider 208 in flight, causing it to be less easily upset by wind turbulence.

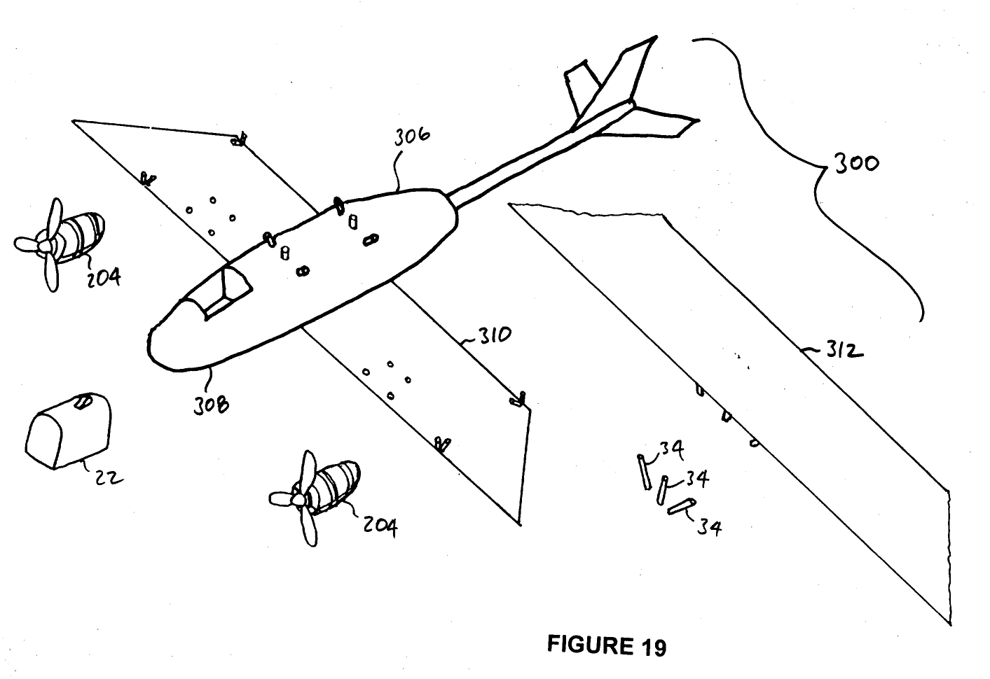

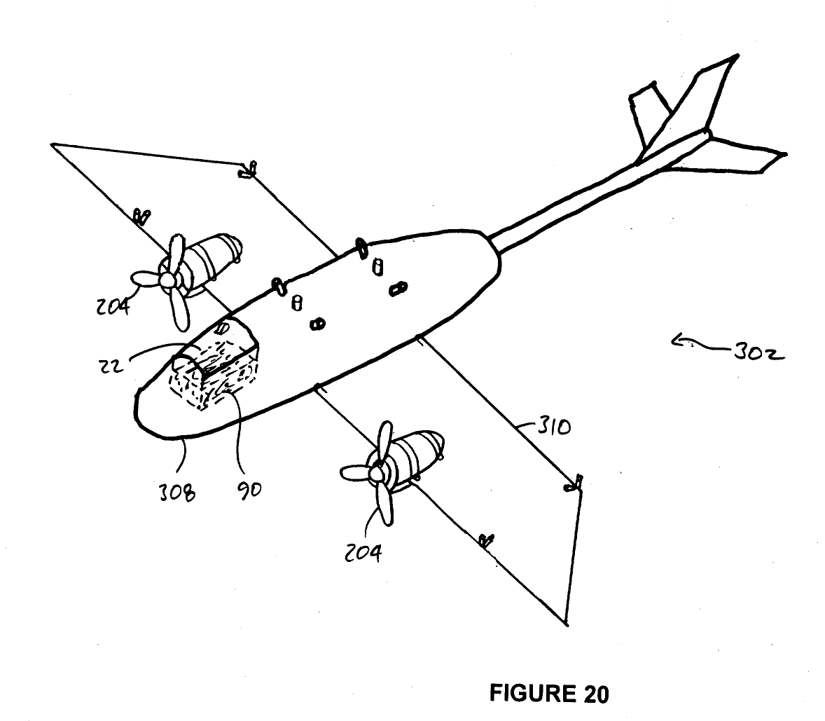

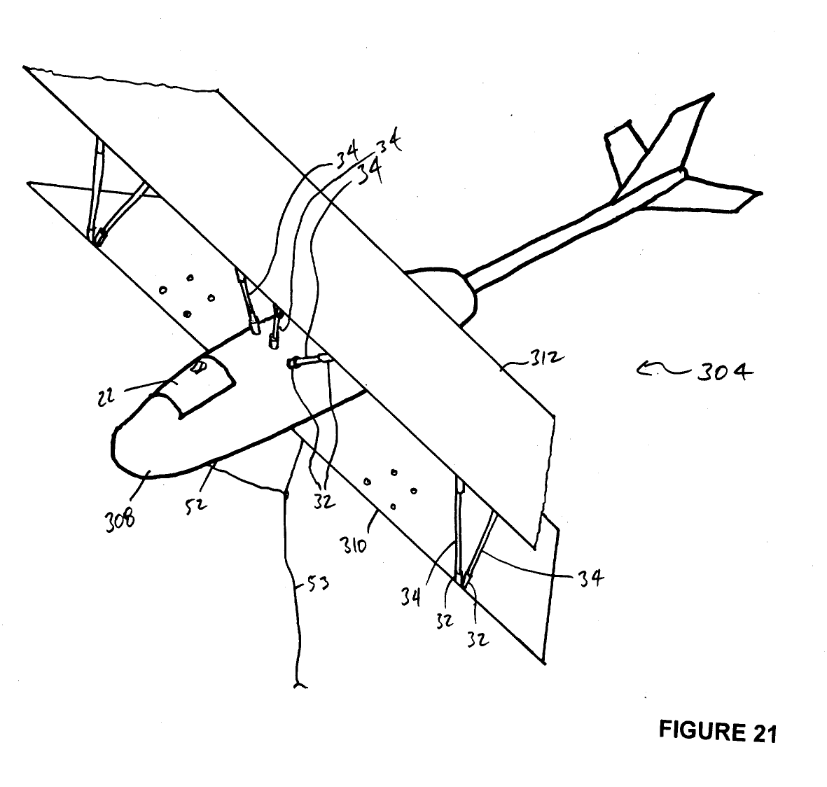

Reference is made to FIG. 19, which shows a kit of parts 300 in accordance with a third embodiment of the present invention. The kit of parts 300 is similar to kit of parts 10 except that kit of parts 300 is configured to operate with one wing when used as a glider 302 (see FIG. 20), and with two wings spaced vertically, similarly to a bi-plane, when used as a kite 304 (see FIG. 21).

The kit of parts 300 includes a glider portion 306 that includes a body 308 and a first wing 310 that may, for example, be permanently mounted thereto. The kit of parts 300 further includes a second wing 312 which is removably mountable to the glider portion 306. The kit of parts 300 may further include a pair of optional propeller assemblies 204, which may be removably mountable to the first wing 310. The kit of parts 300 may further include the optional weight receptacle 22.

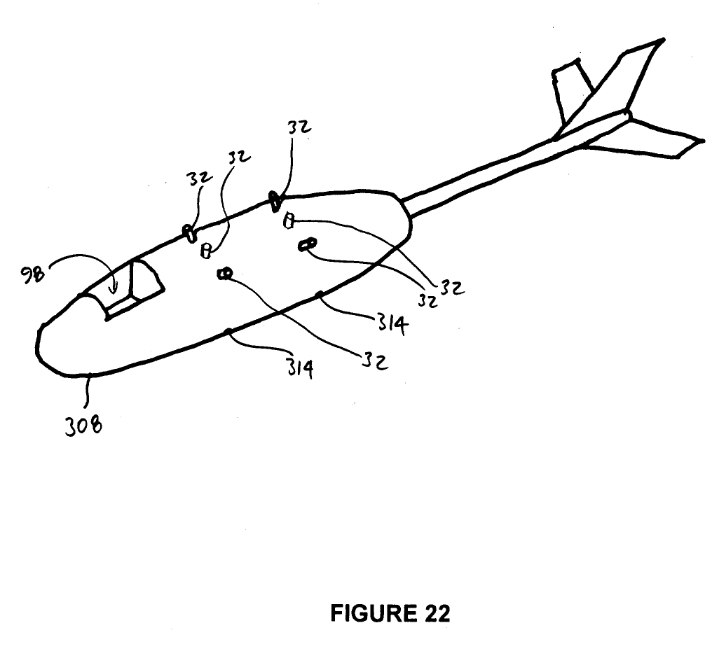

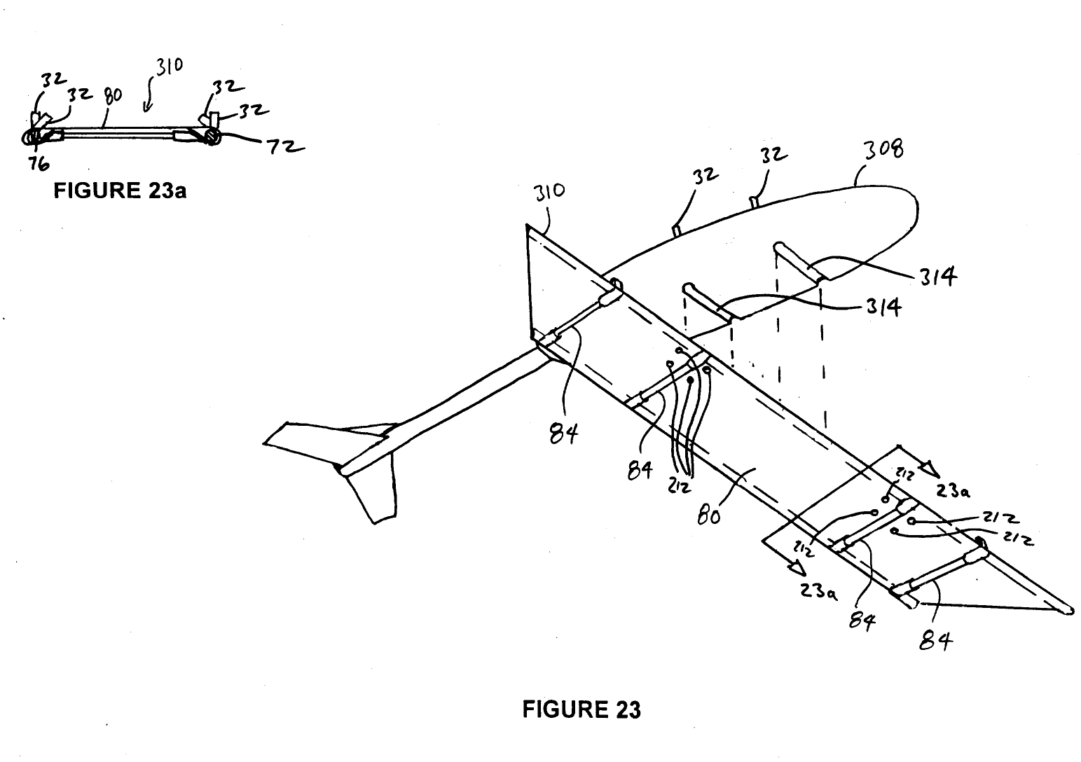

Reference is made to FIGS. 22 and 23. The body 308 is similar to body 16 (see FIG. 4) except that the body 308 includes a first mounting means for both the first wing 310 and a second mounting means for removably mounting the second wing 312. The first mounting means may include a pair of channels 314 (see FIG. 23) on the underside of the body 308. The channels 314 are sized to receive the front and rear spars 72 and 76 of the first wing 310.

The second mounting means may include a plurality of receptacles 32 for connecting the second wing 312. The receptacles 32 may be positioned on the body 308 similarly to the positioning of the receptacles 32 on the body 16 for receiving the kite wing 18 and the glider wing 20 (see FIG. 4).

Referring to FIG. 23, the first wing 310 may be generally similar to glider wing 20 (see FIG. 7). The first wing 310 includes the front spar 72, the rear spar 76 and fabric skin 80 and may include a plurality of ribs 84 to stiffen the wing 310 as necessary. The front and rear spars 72 and 76 may include receptacles 32 positioned near their outside edges. These receptacles 32 are used to connect connecting rods 34 between the first and second wings 310 and 312 to provide support for the outside edges of the second wing 312.

The fabric skin 80 may include apertures 212 as necessary for the mounting of the optional propeller assemblies 204. The apertures 212 may be positioned on both sides of a rib 84. A set of apertures 212 may be positioned about a rib 84 on each side of the body 308, so that two propeller assemblies 204 may be generally symmetrically mounted to the wing 310.

It will be noted that in this embodiment, the propeller assemblies are positioned to be forward-facing. It is preferable in this embodiment that the retaining head 132 on the shaft 104 of the propeller assemblies 204 be rounded at the tip to reduce the risk of injury to a bystander in the event of a collision with the glider 302.

The first wing 310 may be mounted to the body 308 by positioning the front and rear spars 72 and 76 in the channels 314 on the underside of the body 308. Adhesive may be used to permanently affix spars 72 and 76 in the channels 314. The fabric skin 80 may also be joined to the underside of the body 308 by means of adhesive.

Reference is made to FIG. 20. When it is desired to fly the glider 302, the optional propeller assemblies 204 may be mounted to the first wing 310. The optional weight receptacle 22 may be filled with a suitable amount of weighted product 90 for the local wind conditions and may be mounted into the body 308. The glider 302 is then ready for flight.

Reference is made to FIG. 21. When it is desired to fly the kite 304, the second wing 312 may be mounted to the body 308. The second wing 312 adds a suitable amount of wing surface area so that the kite 304 may be supported in flight.

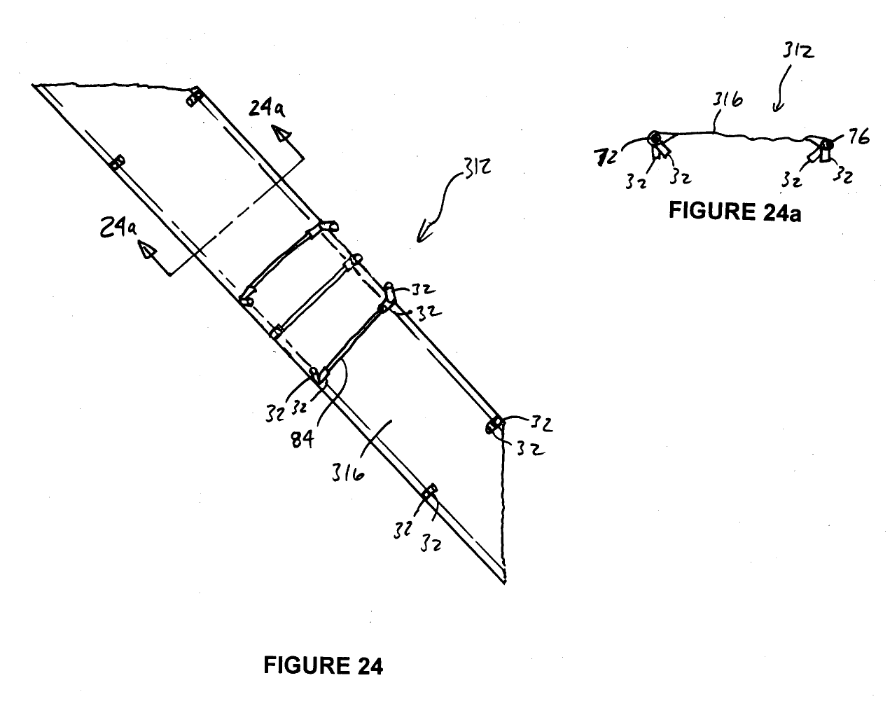

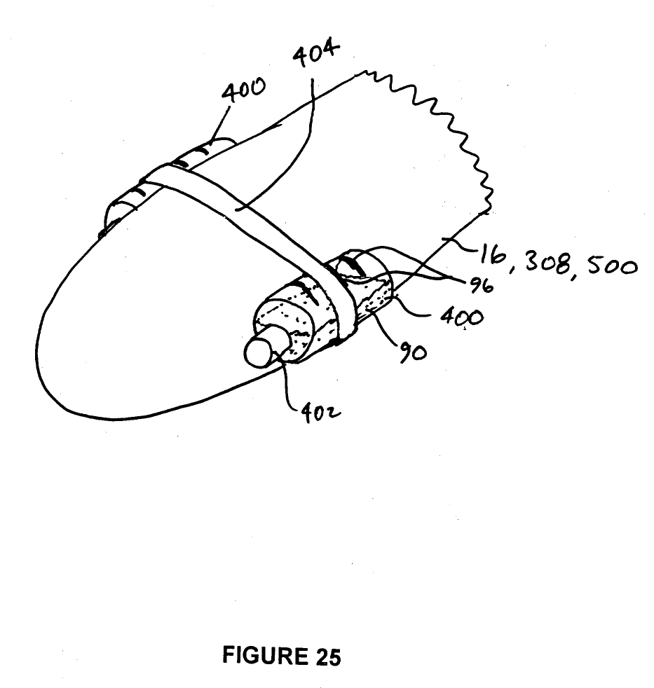

Reference is made to FIG. 24. The second wing 312 may be similar in size and surface area to the first wing 310. The second wing 312 has a front spar 72 and a rear spar 76, and has a fabric skin 316 that extends between them. The front and rear spars 72 and 76 may be connected to each other by ribs 84. The fabric skin 316 may be similar to fabric skin 62, in that it may be oversized so that it bows outwards during kite flight to catch the wind.

Reference is made to FIG. 21. The second wing 312 may have receptacles 32 that are generally centrally positioned on each of the front and rear spars 72 and 76. The receptacles 32 are for removably connecting to connecting rods 34, which, in turn are for removably connecting the second wing 312 to the receptacles 32 on the body 308.

A plurality of receptacles 32 may also be positioned on the front and rear spars 72 and 76 of the second wing 312, spaced from the center of the second wing 312 on both sides of the center of the second wing 312. These receptacles may positioned at a similar point on the second wing 312 to the outermost receptacles 32 positioned on the first wing 310. Connecting rods 34 may be connected between these receptacles 32 on the first wing 310 and the similarly positioned receptacles 32 on the second wing 312, to provide added support for the second wing 312. The connecting rods 34 may, for example, extend both vertically and diagonally between the first and second wings 310 and 312.

When the second wing 312 is connected to the body 308, the second wing 312 may be positioned directly vertically above the first wing 310. Alternatively, the second wing 312 may be offset in the longitudinal direction from the first wing 310, such as for example, a small amount forward of the first wing 310.

When it is desired to fly the kite 304, the second wing 312 is mounted to the glider portion 306 and the kite string 53 is connected to the connection points 52 on the body 308. The kite 304 is then ready for flight.

It is contemplated that the first wing may be positioned above the body 308, instead of below the body 308 as shown in FIGS. 19-23. In this case, the second wing would be removably mountable to the underside of the body 308. For the removable mounting, clips or other connection means may be fixed to the body 308 for capturing some portion of the second wing, such as the front and rear spars.

When the optional weight receptacle 22 is included with any of the kits of parts described, the weight receptacle 22 may be inserted into the receiving aperture 98 in the body with no weighted product when the user desires to fly a kite. Putting the weight receptacle 22 in the aperture 98 also provides the kite with a more streamlined shape and may improve the flying characteristics of the kite.

Reference is made to FIG. 25, which illustrates a pair of optional alternative weight receptacles 400 to replace weight receptacle 22 (FIG. 1). Weight receptacles 400 may be small containers that are cylindrical shaped as shown, or which may have any other suitable shape, such as square, or rectangular. Receptacles 400 each are each covered by a lid 402, which may by a screw-top type, or which may seal the receptacles 400 by any other suitable means. The receptacles 400 may each be filled with weighted product 90 in a similar manner to receptacle 22 (FIG. 1). The receptacles 400 may have graduations 96 similar to those on receptacle 22 (FIG. 1).

The receptacles 400 may be attached to any of the body using a suitable fastening means, such as a band 404 of grippy, elastic material (eg. an elastic band). It will be noted that receptacles 400 are shown mounted externally to the body of a glider/kite. Thus, the aperture 98 (see FIGS. 1, 22) is not required for the mounting of the receptacles 400, and need not be included on the body for this type of mounting. The receptacles 400 may be mounted on either side of the body. Thus, if level flight of the glider is desired, an equal weight of weighted product 90 is placed into the receptacle 400.

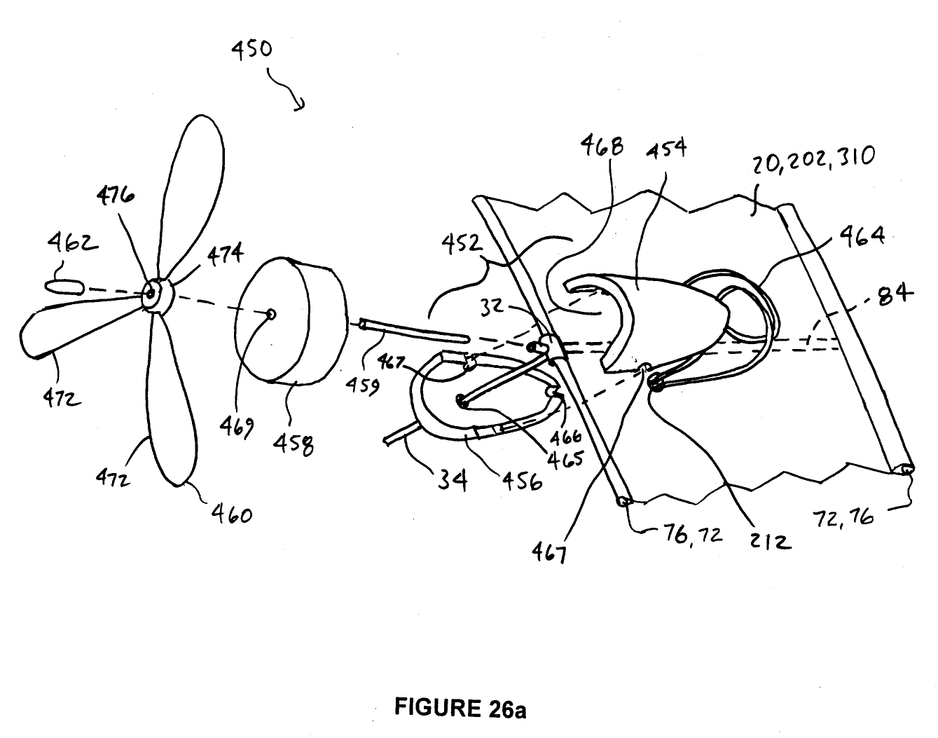

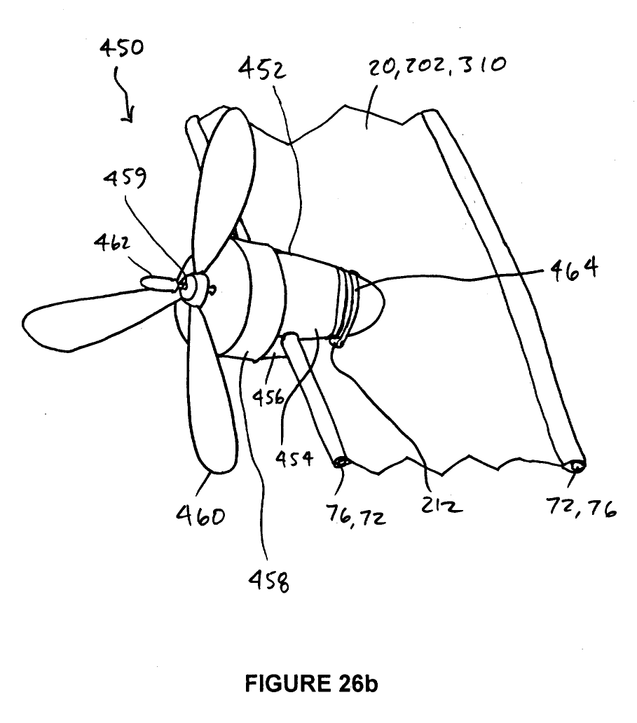

Reference is made to FIGS. 26a and 26b which show a propeller assembly 450 that is an alternative to the propeller assemblies 24 and 204 (FIGS. 1 and 14 respectively), and which can be used with any of the kits of parts of the present invention. The propeller assembly 450 may be mounted to a wing, such as, for example, wing 20, 202 or 310 in a forward or rearward-facing orientation. The mounting is preferably at the junction of a wing spar 72 or 76, a rib 84, and a connecting rod 34 to provide increased stability for the propeller assembly 450 once mounted. It is alternatively possible, however, for the propeller assembly 450 to be mounted along a wing spar 72 or 76 alone or in combination with either a rib 84 or a connecting rod 34.

Propeller assembly 450 includes a housing 452 that includes an upper portion 454 and a lower portion 456, a cover 458, a propeller shaft 459, a propeller 460, a retainer 462 and an elastic band 464. The upper portion 454 of the housing 452 is positioned on top of the wing 20, 202, 310, and the lower portion 456 of the housing 452 is positioned underneath the wing 20, 202, 310. If the propeller assembly 450 is positioned at the junction between a connecting rod 34 and a wing spar 72, 76, the upper or lower portions 454 or 456 can optionally include an aperture 465 through its surface to permit the pass-through of the connecting rod 34. The upper and lower portions 454 and 456 may together define apertures 466 and 467 for the pass-through of the wing rib 84 and the wing spar 72, 76.

The upper and lower portions 454 and 456 may be hollow, and may be made from an expanded foam plastic, such as expanded polyurethane. The upper and lower portions 454 and 456 define an aperture 468 for the pass-through of the propeller shaft 459.

The cover 458 is then positioned over the upper and lower portions 454 and 456 to hold them together. The cover 458 may be made from a semirigid plastic such as nylon. The cover 458 frictionally engages the outer surface of the upper and lower portions 454 and 456 to hold them together, and may include striations or other irregularities on its inside surface to improve the hold. The cover 458 includes an aperture 469 on its face to permit the pass-through of the propeller shaft 459. The propeller shaft 459 passes through the aperture 469 and is frictionally engaged with a receptacle 32 positioned on the wing 20, 202, 310. The propeller 460 includes a plurality of blades 472 which are positioned radially about a central hub 474. An aperture 476 passes longitudinally through the hub 474 so that the propeller 460 may be rotatably mounted to the propeller shaft 459. The propeller may be made from a combination of an expanded foam plastic such as expanded polyurethane for the blades 472 and a more rigid plastic such as nylon for the hub 474. The retainer 462 may be a blind tubular piece of a rubber material that is positioned on the end of the propeller shaft 459 to frictionally engage the shaft 459 and thereby retain the propeller 460 on the shaft 459. Alternatively, the retainer 462 may be integrally formed on one end of the propeller shaft 459.

The elastic band 464 may be a closed loop band, which may be wrapped around the rear of the upper and lower portions 454 and 456 of the housing 452. To accomplish the wrapping, the elastic band 464 may be fed through apertures 212 that may be included on wing 20, 202, 310. The ends of the elastic band 464 may then be hooked onto the upper or lower portion 454 or 456, depending whether the elastic band 464 was fed up or fed down through the apertures 212. A groove (not shown) may optionally be included in one or both of the upper and lower portions 454 and 456 in which the elastic band 464 may be positioned to improve its hold. Alternatively, a strap (not shown), similar to strap 224 or 226 (FIG. 18) may be used in place of the elastic band 464 to hold together the rear of the upper and lower portions 454 and 456.

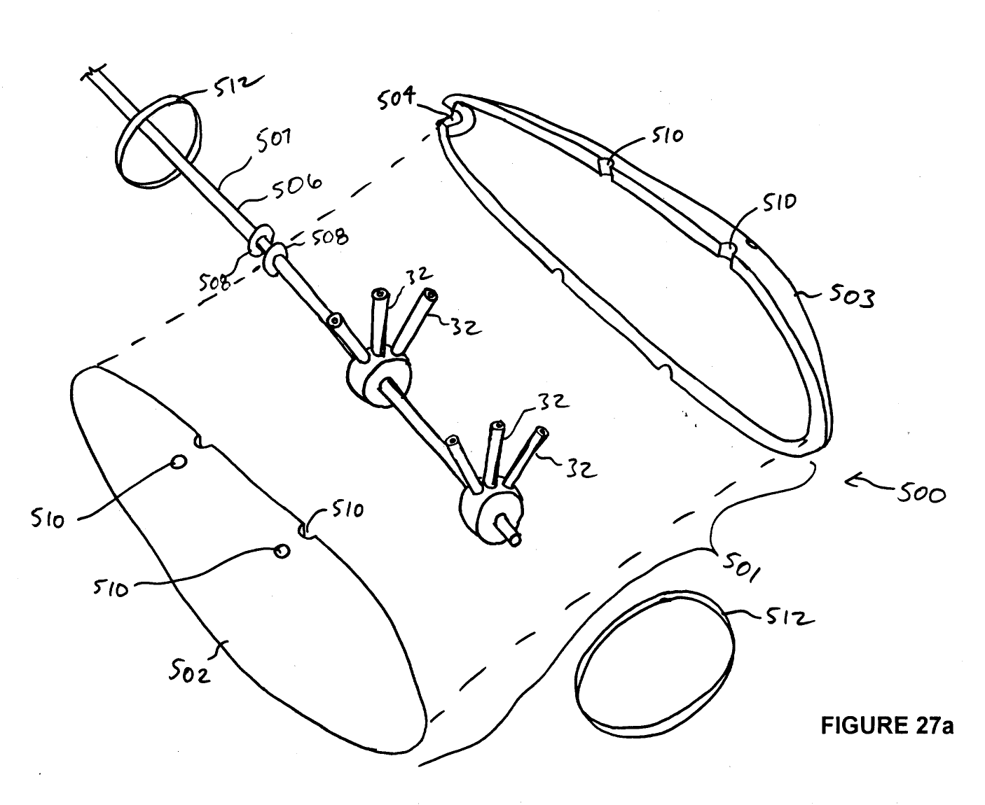

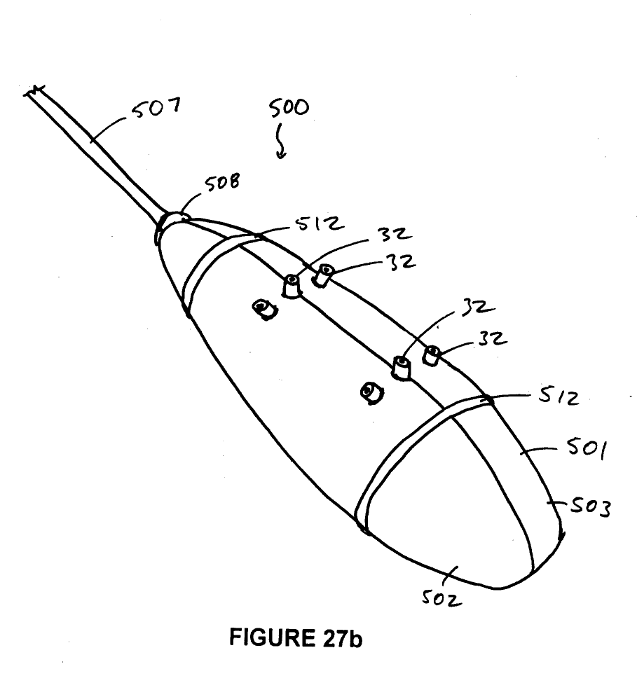

Reference is made to FIGS. 27a and 27b, which show an alternative body 500, which can be used in place of body 16 or body 308. A front portion 501 of the body 500 may be similar to front portion 26 (FIG. 4), but may be split into two hollow portions, such as for example, a left portion 502 and a right portion 503. The left portion 502 and the right portion 503 define an aperture 504 which fits around a shaft 506 of a rear portion 507.

The rear portion 507 may be similar to the rear portion 28 (FIG. 4) and may include a single flange 508 or a pair of flanges 508 to abut and optionally capture the wall of the left and right portions 502 and 503 about the aperture 504, to hold the rear portion 507 in place in the front portion 501. The shaft 506 of the rear portion 507 may extend into the front portion 501 substantially through the length of the front portion 507. Connectors 32 may be fixed to the shaft 506 of the rear portion 507 by any suitable means and may extend through apertures 510 in the front portion 501, for the mounting of the wings 18 and 20 (FIG. 1).

One or more elastic bands 512 may be used to hold the front portion 501 of body 500 together. Alternatively other holding means may be used, such as straps, similar to straps 224 and 226 (FIG. 18) used to hold the propeller assembly together. As a further alternative, the body 500 may be glued together, since regular access to the interior of the front portion 501 is not required by the user. For use in place of body 308 (FIG. 23), body 500 may include channels 314 on the lower surface of front portion 501.

While not shown, the body 500 may optionally include an aperture 98 formed partially in each of the left and right portions 502 and 503 of the front portion 501, for holding the weight receptacle 22 or the weights 100.

Some of the embodiments of the invention described above include a propeller assembly that is rearwardly facing. The rearward facing position is advantageous in that it reduces the risk of the propeller blade itself colliding with and causing injury to a person in the event of a collision between the glider and a person. However, it is contemplated that the propeller assembly may be forward facing to achieve a similar braking effect provided by a rearwardly facing propeller assembly.

The propeller assembly has been described as being mounted on the glider wing in the above embodiments. It is alternatively possible for the propeller to be mounted onto the body of the glider. It is also possible for the propeller assembly to be mountable to the kite wing to improve the realism of the kite in its resemblance to an aircraft.

In some of the embodiments described above, the propeller assembly 24 has been shown and described as being fixedly mounted to the glider wing. It is alternatively possible that the propeller assembly 24 is removably mounted to the glider wing instead in these embodiments.

The kite and glider wings of the embodiments described above have incorporated front and rear spars with a fabric skin extending therebetween and optionally ribs for added strength. It is alternatively possible for either or both of the wings to be made in any other suitable way. For example, the glider wing may be made from solid materials such as balsa and may not require a fabric skin or front and rear spars.

While the above description constitutes the preferred embodiments, it will be appreciated that the present invention is susceptible to modification and change without departing from the fair scope of the invention.

1. A kit of parts for a device that is convertible between a kite and a glider, comprising:
a body;
a first wing that is connectable to the body, the first wing being sufficiently rigid to enable flight as a glider;
a second wing that is removably connectable to at least one of the body and the first wing, the second wing being adapted for increasing the total wing surface area sufficiently for flight as a kite when a kite string is attached to at least one of the body, the first wing and the second wing; and
connecting means for connecting the first and second wings to the body.

2. A kit of parts as claimed in claim 1, wherein the first wing is adapted to remain attached to the body during flight as a kite.

3. A kit of parts as claimed in claim 2, wherein the second wing is positioned substantially above the first wing during flight as a kite.

4. A kit of parts as claimed in claim 1, wherein the first wing is adapted to be removed from the body when the second wing is attached to the body for flight as a kite.

5. A kit of parts as claimed in claim 1, wherein the first wing is more rigid than the second wing.

6. A kit of parts as claimed in claim 1, wherein the first wing comprises a first front spar, a first rear spar and a first fabric skin extending tautly between the first front and rear spars.

7. A kit of parts as claimed in claim 6, wherein the first wing further comprises at least one first rib connected between the first front and rear spars.

8. A kit of parts as claimed in claim 1, wherein the second wing comprises a second front spar, a second rear spar and a second fabric skin extending between the second front and rear spars.

9. A kit of parts as claimed in claim 8, wherein the second wing further comprises at least one second rib connected between the second front and rear spars.

10. A kit of parts as claimed in claim 1, wherein the first wing comprises a first front spar, a first rear spar and a first fabric skin extending generally tautly between the first front and rear spars, and the second wing comprises a second front spar, a second rear spar and a second fabric skin extending between the second front and rear spars.

11. A kit of parts as claimed in claim 10, wherein the first wing comprises at least one first rib extending between the first front and rear spars.

12. A kit of parts as claimed in claim 11, wherein the second wing comprises at least one second rib extending between the second front and rear spars.

13. A kit of parts as claimed in claim 12, wherein the at least one first and second ribs are the same and there are more first ribs on the first wing than there are second ribs on the second wing.

14. A kit of parts as claimed in claim 1, further comprising at least one weight receptacle mountable on the body, the at least one weight receptacle adapted to hold a weighted material when the first wing is connected to the body for controlling the stability of the glider in flight.

15. A kit of parts as claimed in claim 14, wherein the at least one weight receptacle is adapted to hold water.

16. A kit of parts as claimed in claim 14, wherein the at least one weight receptacle is graduated to indicate the relationship between a fill volume of the weight receptacle for a given weighted material and the wind speed in which the glider is to be flown.

17. A kit of parts as claimed in claim 14, wherein the at least one weight receptacle is adapted to releasably hold a weighted material.

18. A kit of parts as claimed in claim 14, wherein the at least one weight receptacle is integral with the body.

19. A kit of parts as claimed in claim 1, further comprising a plurality of weights, the weights being positionable on the body when the first wing is connected to the body, for controlling the stability of the glider in flight.

20. A kit of parts as claimed in claim 1, further comprising a velocity regulator that is connectable to at least one of the body and the first wing, the velocity regulator being adapted to dampen accelerations of the glider during flight.

21. A kit of parts as claimed in claim 20, wherein the velocity regulator is adapted to provide a braking force that increases as the velocity of the glider increases.

22. A kit of parts as claimed in claim 21, wherein the velocity regulator includes a propeller that is rotatably mounted to at least one of the body and the first wing.

23. A kit of parts for a device that is convertible between a kite and a glider, comprising:
a body;
a wing connected to the body, the wing comprising a front spar, a rear spar and a fabric skin extending between the front and rear spars, the body and the wing being connectable to a kite string for flight as a kite; and
at least one rib, the at least one rib being removably connectable between the front and rear spars to make the wing sufficiently rigid so that the wing and the body may be flown as a glider.

24. A kit of parts as claimed in claim 23, further comprising at least one weight receptacle mountable on the body, the at least one weight receptacle adapted to hold a weighted material when the first wing is connected to the body for controlling the stability of the glider in flight.

25. A method of converting a kite to a glider, the kite comprising a body, a kite wing that is removably attached to the body, and a kite string that is removably attached to at least one of the body and the kite wing, the method comprising completing the following steps in any order:
removing the kite string from the at least one of the body and the kite wing;
removing the kite wing from the body; and
attaching a glider wing to the body, the glider wing being sufficiently rigid to enable flight as a glider.

26. A method as claimed in claim 25, further comprising adding a selected amount of a weighted product to the body to adjust the center of gravity of the body.

27. A method as claimed in claim 25, further comprising:
attaching at least one propeller assembly to at least one of the glider wing and the body.

28. A method of converting a kite to a glider, the kite comprising a body, a wing attached to the body, and a kite string removably attached to at least one of the body and the wing, the wing including a front spar, a rear spar and a fabric skin extending between the front and rear spars, the method comprising completing the following steps in any order:
removing the kite string from the at least one of the body and the wing; and
attaching at least one wing rib between the front and rear spars to stiffen the wing.

29. A method as claimed in claim 28, further comprising adding a selected amount of a weighted product to the body to adjust the center of gravity of the body.

30. A method as claimed in claim 28, wherein the at least one wing rib is adapted to increase the tautness of the fabric skin when attached between the front and rear spars.

31. A method of converting a glider to a kite, the glider comprising a body, a wing attached to the body, the wing including a front spar, a rear spar, a fabric skin extending between the front and rear spars, and at least one rib connected between the front and rear spars, the method comprising completing the following steps in any order:
removing the at least one wing rib from between the front and rear spars to reduce the stiffness of the wing; and
adding a kite string to at least one of the body and the wing.

32. A method as claimed in claim 31, wherein the body has a weighted product attached thereto and the method further comprises removing at least a portion of the weighted product from the body.

33. A method as claimed in claim 31, wherein the removal of the at least one wing rib is adapted to decrease the tautness of the fabric skin.

34. A method of converting a glider to a kite, the glider comprising a body, a first wing attached to the body, the first wing being a glider wing, the method comprising completing the following steps in any order:
attaching a second wing to the body to increase the overall wing surface area; and
attaching a kite string to at least one of the first wing, the second wing and the body.

35. A method as claimed in claim 34, wherein the body contains a weighted product and the method further comprises removing the weighted product from the body.

36. A method as claimed in claim 34, wherein the second wing has a surface area that is larger than the surface area of the first wing and the method further comprises removing the first wing from the body.
